(19) United States
(12) Patent Application Publication
(10) Pub. No.: US 2020/0353695 A1
(43) Pub. Date: Nov. 12, 2020

(54) BONDING OBJECTS TOGETHER

(71) Applicant: MultiMaterial-Welding AG, Stansstad (CH)

(72) Inventors: Jörg Mayer, Niederlenz (CH); Joakim Kvist, Nidau (CH)

(21) Appl. No.: 16/476,570

(22) PCT Filed: Jan. 9, 2018
(86) PCT No.: PCT/EP2018/050463

§ 371 Date: Jul. 9, 2019

(30) Foreign Application Priority Data
Jan. 11, 2017 (CH) 00034/17

(51) Int. Cl. B29C 65/00; B29C 65/06; B29C 65/08

(52) U.S. Cl. CPC B29C 66/30321; B29C 65/06; B29C 65/08; B29C 66/022; B29C 66/1224; B29C 66/474; B29L 2031/30; B29C 66/7212; B29C 66/73116; B29C 66/7392; B29C 66/7394; B29C 66/7422; B29C 66/74283; B29C 66/712

(57) ABSTRACT

Methods of bonding a first object to a second object, including the steps of: providing the second object having a protrusion; providing the first object having a thermoplastic material; positioning the first object relative to the second object such that an assembly of the first and the second object is formed; applying a relative force between the second and first objects and applying mechanical vibration to the assembly of the first and the second object until at least a flow portion of the thermoplastic material becomes flowable and flows around the protrusion; and causing the thermoplastic material to re-solidify. The first object may be a connecting element including a feedthrough, wherein the second object has a corresponding opening. The protrusion may be deformed such that the protrusion has an undercut relative to an axis along which the first and second objects are pressed against each other.

### BACKGROUND OF THE INVENTION

### Field of the Invention

The invention is in the fields of mechanical engineering and construction, especially mechanical construction, for example automotive engineering and aviation engineering.

### Description of Related Art

In the automotive, aviation and other industries, due to new manufacturing techniques and new materials as well as the constant need for increased efficiency, methods of bonding objects together remain a challenge.

For example, one of the objects to be bond together may be formed by a production process that does either not allow the formation of features favourable for certain bonding and/or sealing methods or the formation of said features complicates the production process significantly.

Many embodiments of methods for bonding a first object including a deformable, for example thermoplastic, material or consisting of such a material to a second object require structures on the second object that are capable to form a positive fit connection with the deformable material. However, such structures are very difficult to realize if the second object is formed by pressure casting, for example. Undercuts and sharp edges are examples of structures that are difficult to realize with some casting processes.

### SUMMARY OF THE INVENTION

It is an object of the present invention to provide approaches and methods for bonding objects together, especially for bonding a first object, in particular a connecting element, to a second object.

The term “connecting element” includes any element that makes the controlled transfer of operating resources, such as power, electric signals, a liquid or a gas, from one side of an object to another side of the object or into said object possible. Connectors, in particular connectors including wires or other electrical conductors, especially plugs or sockets, and fluid conduits are examples of connecting elements.

A requirement for the connection between the objects, hence, may be that it provides a full-scale seal around an opening in one of the objects. Another requirement may be that the connection has a certain minimal strength. Yet another requirement may be the method for making the connection need as less changes to established production processes for the objects as possible. A further, optional, requirement may be that it is possible to make the connection with access only from the outside. An even further requirement may be that no brittle material is involved. Yet another requirement may be that the method can be integrated in a fully automated process, for example after the ‘paint shop’ (possible corrosion issues). It is therefore a further object of the invention that at least one of these requirements is at least partially met.

It is a further object to bond the first object to the second object, which method is especially suited for fixing the first object to the second object in a precisely defined relative position even in situations where for practical reasons it is not easily possible to precisely define joining locations on the second object.

In accordance with the invention, a method of bonding a first object to a second object is provided, wherein the first and second objects may have abutting surface portions that locally are to lie flattishly against each other, and the second object, for example, has a complex surface shape. In such situations, in accordance with the prior art, an adhesive bond is used for the fastening. However, adhesive bonds have certain limitations.

The invention provides an alternative solution. In accordance with a first aspect of the invention, the method of bonding the first object to the second object includes the steps of:
Providing the second object. The second object includes a protrusion and an opening.
   In a first group of embodiments according to the first aspect of the invention, the protrusion does not form an undercut. Hence, it is per se not capable to contribute to a positive fit connection. However, the protrusion can be such that it is deformable, in particular plastically deformable, by a force applied to the protrusion.
   In a second group of embodiments according to the first aspect of the invention, the protrusion forms an undercut.
   The second object can be formed by die casting (pressure casting), for example. In particular in embodiments of the first group, the second object can be formed by pressure casting, for example.
   The protrusion can be a protrusion surrounding the opening continuously.
   The protrusion can be arranged in the opening of the second object. For example, it can protrude from at least one of a lateral wall of the opening and a surface formed by a decrease, in particular a step-wise decrease, of a diameter of the opening.
Providing the first object. The first object includes a thermoplastic material, in particular a thermoplastic material in a solid state, and a feedthrough.
   In embodiments according to the first aspect of the invention, the first object is a connecting element as described above. In particular, the first object can be a connector including wires for guiding power and/or signals, for example.
Positioning the first object relative to the second object such that an assembly of the first and the second object is formed. In particular, the first object is positioned relative to the second object, such that the thermoplastic material is in contact with the protrusion or with the deformed protrusion.
   The assembly can include an engaging of the protrusion with a corresponding counterpart on the first object, for example a pushing of the protrusion in an indentation, opening, recess etc. of the first object. In addition or alternatively, the second object can include an indentation, opening, recess etc. into which a protrusion of the first object is pushed.
Applying a relative force between the second and first objects and applying mechanical vibration to the assembly of the first and the second object until at least a flow portion of the thermoplastic material becomes flowable and flows around the protrusion. In particular, the mechanical vibration is applied to at least one of the first and second object.
   The applying of the relative force and the mechanical vibration can result in a partial softening of the first object, in a partial liquefaction of the first object or in a liquefaction of a first portion of the first object and a softening of a second portion of the first object.
Causing the thermoplastic material to re-solidify.

For example, the feedthrough can include or embed wires, such as wires for power supply and/or signal transmission. However, it can also include a conduit (especially a pipe) for a gas or a liquid.

If the protrusion forms an undercut or if the protrusion is deformed to form an undercut, the undercut and the thermoplastic material can yield a positive-fit connection between the first and second objects after the thermoplastic material has re-solidified.

In this text (independent of the aspect of the invention), in embodiments in which the protrusion forms an undercut, the undercut is formed with respect to a proximodistal axis, i.e. an axis along which the first and second objects are pressed against each other (also called “axis” in this text). In other words: The undercut is with respect to axial directions.

In accordance with a second aspect of the invention, the method of bonding the first object to the second object includes the steps of:
Providing the second object. The second object includes a protrusion, wherein the protrusion does not form an undercut. Hence, the protrusion is per se not capable to contribute to a positive fit connection. However, the protrusion is such that it is deformable, in particular plastically deformable, by a force applied to the protrusion. The second object can be formed by pressure casting, for example.
   The second object can include an opening. The protrusion can be a protrusion surrounding the opening continuously.
   The protrusion can be arranged in the opening of the second object. For example, it can protrude from at least one of a lateral wall of the opening and a surface formed by a decrease, in particular a step-wise decrease, of a diameter of the opening.
Providing the first object. The first object including a thermoplastic material, in particular a thermoplastic material in a solid state.
   The first object can include a feedthrough as an optional feature.
Deforming the protrusion. In particular, deforming the protrusion plastically and/or deforming the protrusion such that an undercut is formed.
   For example, the deformation can include or consist of bending the protrusion. In particular, the deformation can be such that the protrusion does not break or fracture, neither locally nor globally.
Positioning the first object relative to the second object such that an assembly of the first and the second object is formed. In particular, the first object is positioned relative to the second object, such that the thermoplastic material is in contact with the deformed protrusion.
   The assembly can include an engaging of the protrusion with a corresponding counterpart on the first object, for example a pushing of the protrusion in an indentation, opening, recess etc. of the first object. In addition or alternatively, the second object can include an indentation, opening, recess etc. into which a protrusion of the first object is pushed.
Applying a relative force between the second and first objects and applying mechanical vibration to the assembly of the first and the second object until at least a flow portion of the thermoplastic material becomes flowable and flows around the protrusion.
   The applying of the relative force and the mechanical vibration can result in a partial softening of the first object, in a partial liquefaction of the first object or in a liquefaction of a first portion of the first object and a softening of a second portion of the first object.
Causing the thermoplastic material to re-solidify.

In particular, at least a portion of the re-solidified thermoplastic material and the deformed protrusion can form a positive fit connection.

Besides a connecting element, the first object in embodiments according to the second aspect may, for example, be a plastic carrier structure for a functional element (that may be exchangeable), for example a lighting element, a sensor, a display element, an control and/or input element, a transducer, for example loudspeaker, or any combination of these. Alternatively, the first object may instead of a carrier structure for such element be such an element, wherein such element then has a thermoplastic portion.

For embodiments according to the first or the second aspect, the step of causing the thermoplastic material to re-solidify may include maintaining the relative force for some more time, for example until the flow portion is not flowable any more, with equal or smaller or higher magnitude.

For example, any deformable protrusion can be at least one of:
A protrusion including at least two protruding extensions that are deformable in different directions. In particular, the protruding extensions are deformable such that a tip of a first protruding extension is bent away from a tip of a second protruding extension.
A protrusion from a plurality of protrusion. The protrusions of the plurality of protrusions can have the same characteristics. The protrusions can be arranged around the opening (if present), for example in an equidistantly manner.
A protrusion protruding from a surface portion of the second object, wherein the surface portion is flat in the region of the protrusion at least, and wherein the protrusion includes an extension in a direction parallel to the surface portion that is larger than an extension in another direction parallel to the surface portion. In particular, the surface portion can have the shape of a wall.
A protrusion that forms a lip surrounding the opening (if present) continuously. The protrusion that forms the continuous lip can be arranged in the opening. For example, it can protrude from a lateral wall of the opening.
   The opening can have the surface formed by the decrease of a diameter of the opening. This means that the opening can be formed by a first portion having a first diameter and a second portion having a second diameter that is smaller than the first diameter. In such an embodiment, the protrusion can form a lip surrounding the second portion continuously by being arranged on the surface formed by the decrease in diameter.
A protrusion having a predefined deformation location, for example a line along which the protrusion deforms if a force is applied to a portion of the protrusion that is more distant from the second object than the deformation location.
A protrusion including a first portion that protrudes form the second object and a second portion that is on top of the first portion. The second portion can be beyond the deformation location. The first portion can form a continuous lip around the opening (if present) or in the opening, wherein the second portion is non-continuous including a plurality of parts. The parts can be connected to each other via the first portion, only. Each of the parts can be deformable such a plurality of undercuts are formed.
A protrusion including a material, for example a polymer, having a melting point such that the protrusion softens during the step of applying the relative force and the mechanical vibration. In particular, the protrusion can soften while it is in contact with flowing thermoplastic material. In this case, the material of the protrusion has a melting point that is higher than the melting point of the thermoplastic material. The protrusion can consist of the material.
   In addition or alternatively, the protrusion can be designed to have a high fluid resistance. In other words, the protrusion can be designed in a manner that a force on the protrusion generated by the thermoplastic material flowing around the protrusion is increased, for example maximized.
   One can envisage to form portions of the second object other than the protrusion or the whole second object from the material having a melting point such that it can soften during the step of applying the relative force and the mechanical vibration.

The second object can be treated such that the protrusion includes at least one of edges and surface roughness, i.e. the second object can be equipped for supporting softening and/or liquefaction of thermoplastic material when in contact with the protrusion. Especially, if the second object is made by die casting, a post-processing step may be made, for example by mechanical removal processes (milling, grinding or the like) or sandblasting or lasering. Such a post-processing step may especially be advantageous since die casting does usually not yield any sharp edges or the like. Further, such a post-processing step may yield a micro-structured surface or surface portion (for example the surface of the protrusion) of the second object. This enables the generation of a positive-fit connection between the first and second object on the micro-scale by flowable thermoplastic material that interpenetrates the microstructures of the surface of the second object before the thermoplastic material re-solidifies.

The second and/or first object can include energy directors, i.e. structures at which mechanical vibration and/or force applied are focused and/or couple into the thermoplastic material in an efficient manner.

The step of applying a relative force between the first and second objects and the step of applying vibration to impinge may be carried out simultaneously (this does not exclude the possibility that the relative force may be maintained after the vibration stops). The step may include pressing, by a sonotrode, the first object against the second objet.

Such a sonotrode may include a distally facing coupling face that during the process is in contact with a proximally facing coupling surface of the first object.

The coupling face of the sonotrode can be adapted to at least one of the position of the protrusion, the number of protrusions and their positions, and the shape of the protrusion(s).

In embodiments including a plurality of protrusions and/or including at least one protrusion with an extension along a line on the second object, for example such that the at least one protrusion runs at least partly around the opening, the step of applying the relative force between the second and first objects and of applying mechanical vibration to at least one of the first and second object can be carried out simultaneously for all protrusions and/or the complete extension of the at least one protrusion or with a shifting movement or sequentially for different locations of the protrusions and/or the extension of the at least one protrusion.

In embodiments in which the protrusion runs around the opening or in the opening, the step of applying the relative force between the second and first objects and of applying mechanical vibration to at least one of the first and second object can be carried out until a seal around the entire opening is achieved. For example, the protrusion or a side of the protrusion is uninterruptedly embedded in the thermoplastic material along its whole extension. In particular, the protrusion has a closed form that encircles the opening.

For the process, the sonotrode may be caused to be guided along a coupling face of the sonotrode. For example, the sonotrode may be a rolling sonotrode, or it may be a gliding sonotrode gliding along the opening, for example. In particular, the movement of the sonotrode can follow the line of extension of the at least one protrusion.

Alternatively, the sonotrode may, similarly to a punching device, have a shape corresponding to the arrangement of the protrusions and/or the extension of the at least one protrusion, so that the method may be carried out for all protrusions and/or the complete extension of the at least one protrusion simultaneously.

The sonotrode can have a coupling face that includes an opening, e.g. for wires or tubes, that project away from the bonding area between the first and second object. For example, the coupling face can be ring-like or like a slit ring.

Requirements for the bond to the second object may include—independent of the aspect of the invention—any of resistance to vibration load, resistance to acceleration forces, the property of being leakproof, or having a defined position and, if applicable, gap dimension for technical and/or optical reasons.

In an example, the second object may be a part of an automobile body, and the first object may be a specific automobile part to be bonded to the automobile body.

In embodiments of the method according to the first or second aspect in which the second object includes the opening, the step of positioning the first object relative to the second object can include positioning the first object in a manner that after the step of causing the thermoplastic material to re-solidify the first object extends at least partially through the opening.

In particular in such embodiments, the bonding formed between the first and second object by the method can be arranged within the opening, for example by the protrusion protruding from at least one of the lateral wall of the opening and the surface formed by a decrease, in particular a step-wise decrease, of a diameter of the opening. The decrease of the diameter can lead to the above-mentioned first and second portion of the opening.

The protrusion arranged in the opening can be designed to bond the first object to the second object (i.e., for fixing the first object to the second object) or for generating a seal or for bonding the first object to the second object and for generating a seal.

Positioning the first object in a manner that after the step of causing the thermoplastic material to re-solidify the first object extends at least partially through the opening can include positioning a distal end of the first object in the opening before the step of applying the relative force and the mechanical vibration to cause liquefaction of the flow portion.

For example, the distal end of the first object can be inserted into the opening along an insertion direction. The opening can include proximally the first portion with the first diameter and distally of the first portion the second portion with the second diameter that is smaller than the first diameter.

The distal end of the first object can include a diameter perpendicular to the insertion direction that is smaller than the first diameter but larger than the second diameter such that a portion of the distal end of the first object is pressed against the surface formed by the decrease of the diameter from the first diameter to the second diameter in the step of applying the relative force and the mechanical vibration. Therefore, at least a portion of the distal end of the first object becomes flowable and flows around the protrusion present in the opening (for example, protruding from a lateral wall or the surface against which the distal end is pressed) and possibly around an edge formed by said decrease of the diameter.

For example, the first object can include an adaptable edge and/or and adaptable end portion.

In such an embodiment, neither needs the diameter of the distal end of the first object to be precisely adapted to first and/or second diameter nor needs the first object to be precisely positioned in the opening. Rather, the method is able to compensate for manufacturing tolerances and/or inexact positioning. In other words, the first object is equipped for adapting to the geometry of the second object by becoming flowable.

In particular, a seal can be generated by melt flow. The seal can be improved by the geometry of the opening of the second object and/or surface roughness, for example.

For example, the protrusion can form an undercut in the opening or the opening can include an undercut in addition to the protrusion (that may form an undercut, too).

Embodiments in which the step of positioning the first object relative to the second object include positioning the first object in a manner that after the step of causing the thermoplastic material to re-solidify the first object extends at least partially through the opening can form a form lock and/or a seal that is/are arranged in the opening of the second object.

In an embodiment of the method according to the first or second aspect and including the step of deforming the protrusion (i.e., according to the first group of the first aspect and methods according to the second aspect), the method further includes the step of providing a deformation element and the step of positioning the deformation element relative to the protrusion, in particular bringing the deformation element in contact with the protrusion. In such an embodiment, the step of deforming the protrusion includes deforming the protrusion by applying a force to the protrusion via the deformation element.

In other words, the deforming element engages with the protrusion such that a force can be applied to the protrusion by movement of deforming element relative to the protrusion, for example.

The step of positioning the deformation element relative to the protrusion is a step prior to the step of positioning the first object relative to the second object such that an assembly of the first and the second object is formed

In an embodiment, the first object includes the deformation element.

However, the deformation element can be a separate element that is provided in the method.

In a sub-group of embodiments according to any embodiment of the second aspect or according to any embodiment of any group of the first aspect, the step of positioning the first object relative to the second object such that an assembly of the first and the second object is formed includes positioning the first object relative to the protrusion such that the thermoplastic material of the first object is in physical contact with the protrusion.

In particular, the protrusion forms an undercut either by being deformed in a step prior to the step of positioning the first object relative to the second object such that an assembly of the first and the second object is formed or by providing a second object that includes a protrusion forming an undercut.

In embodiments including the deformation element, the step of positioning the first object relative to the second object such that an assembly of the first and the second object is formed is done after a step of removing the deformation element.

In embodiments in which the first object includes the deformation element, the step of positioning the first object relative to the second object such that an assembly of the first and the second object is formed can include re-positioning the first object after the step of deforming the protrusion. In particular, the first object can be re-positioned such that the deformed protrusion is in contact with a planned joining location instead of being in contact with the deformation element. However, a complete re-movement of the first object may not be needed.

The first object can include an indentation arranged on the first object such that the protrusion engages with the indentation during the step of positioning the first object relative to the second object such that an assembly of the first and the second object is formed.

In particular, the indentation is arranged on a first object surface portion.

The first object surface portion is the portion of the surface of the first object that faces and/or is at least partly in contact with a portion of the surface of the second object (called the second object surface portion in the following) after bonding of the first and second objects.

In a further sub-group of embodiments according to the first or second aspect, the method is adapted to generate a sealed connection between the first and the second object. At least in embodiments of this sub-group, the step of providing a second object includes providing a second object including an opening, wherein the seal is formed by involving an external surface of the second object and/or a surface in the opening.

In an embodiment, the first object includes a first portion including the thermoplastic material and a second portion including an elastomer.

In particular, the elastomer is elastically deformable but it does not soften further or liquefy at forces and vibrations applied during the method.

The second portion can be arranged to form a seal after bonding of the first and second objects. In particular, the elastomer can be arranged on or protrude out of the first object. In addition, the elastomer can be arranged to run around the opening of the second object after bonding the first and second objects.

In particular, the second portion is arranged on the first object such that it is pressed against the second object after the step of causing the thermoplastic material to re-solidify. This can be done by applying the relative force and mechanical vibration for a time sufficient to cause such an amount of thermoplastic material to flow around the protrusion that the second portion is clamped between the first and second objects.

In addition, the relative force applied is such that an elastic deformation of the second portion is caused.

In an embodiment of the sub-group adapted to generate a sealed connection that is alternative to the embodiment including a first object with the first and second portion, the method includes the further step of positioning a sealing ring around the opening or in the opening prior to the step of positioning the first object relative to the second object such that an assembly of the first and the second object is formed.

The second object can include an indentation that runs around the opening or in the opening and that is arranged to accommodate the sealing ring.

Also in embodiments including the sealing ring, the relative force and mechanical vibration are applied for a time sufficient to cause such an amount of thermoplastic material to flow around the protrusion that the sealing ring is clamped between the first and second objects.

In addition, the relative force applied is such that an elastic deformation of the sealing ring is caused.

In many embodiments of the first or the second aspect, the thermoplastic material becomes soft but not liquid during the step of applying a relative force and mechanical vibration. Hence, the first and second objects are equipped to be bonded to each other in any spatial orientation. In particular, this allows the use of the methods in applications in which the first object is bonded on top of the second object. In other words, it allows the use of the methods in configurations in which gravity would cause a flow out of liquefied material.

In a further embodiment of any embodiment according to the first or second group, the second object includes a fastening portion having a positive fit shape with an undercut and the first object includes an extension including thermoplastic material. For example, the fastening portion includes an opening in the second object surface portion or in a surface of the opening (if present) of the second object and a cavity including an undercut.

In such an embodiment, the step of positioning the first object relative to the second object includes positioning an extension of thermoplastic material relative to the fastening portion. For example, the extension can be positioned in the opening and/or the cavity of the fastening portion.

Further, the step of applying the relative force and mechanical vibration causes the extension of the thermoplastic material to flow such that the fastening portion and the extension constitute a positive fit between the first and second object after re-solidification of the thermoplastic material. For example, the flowable portion of the extension fills the cavity or at least a part of it.

In particular in, but not restricted to, embodiments including a fastening portion, the thermoplastic material of the first object can liquefy at least partly. For example, it can liquefy to fill and/or flow around an undercut or to fill a cavity.

Specific location of liquefaction can be predefined by the use of energy directors. The energy directors can be arranged on the first and/or second object.

The fastening portion can run around the opening in an uninterrupted, i.e., continuous, manner. By doing so, the fastening portion and the extension of thermoplastic material can form both a positive fit connection and a seal between the first and second object.

In an embodiment, the first object includes a recess in which thermoplastic material is arranged. In particular, the recess is open towards the first object surface portion and it can be equipped for building a seat for the thermoplastic material. For example, a diameter of the recess can decrease towards the first object surface portion. However, it is also possible that the thermoplastic material is hold in the recess in another manner, e.g., by being attached to the walls forming the recess.

In such an embodiment, the step of positioning the first object relative to the second object can include bringing the protrusion in contact with the thermoplastic material arranged within the recess, in particular with a surface of the thermoplastic material accessible from the first object surface portion side of the first object.

In particular, the thermoplastic material arranged in the recess can have elastomeric properties by being a thermoplastic elastomer, for example. In other words, the thermoplastic material can be equipped to flow around the protrusion in the step of applying the relative force and mechanical vibration and to deform elastically in reaction to a force applied to it via the embedded protrusion. Hence, the first and second objects can be bonded in a way that relative movements between the first and second objects are still possible after bonding. In particular, relative movements caused by different characteristics of the material(s) of the first object and the material(s) of the second object and/or different exposure to the environment are possible. For example, relative movements caused by temperature changes and/or by vibrations are possible.

Hence, the bonding formed by the thermoplastic material arranged in the recess and the protrusion can be flexible and/or damping.

The recess formed by a material that is rigid in the range of forces and mechanical vibration applied in the method and during use of the bonded first and second objects. For example, it includes or consists of a thermoplastic material that does not soften at the forces and mechanical vibration.

Further, the thermoplastic material and the protrusion can form a seal, in particular if the recess, and possibly the protrusion, runs around the opening.

Further, the invention concerns a connecting element, in particular a connecting element for use in a method according to any of the disclosed embodiments. In many embodiments, the connecting element corresponds to the first object provided in the method.

The following may apply to all aspects:
The liquefaction of the flow portion may be primarily caused by friction between the vibrating object and the surface of the respective other object, which friction heats the object that has the thermoplastic material superficially.

In this text the expression “thermoplastic material being capable of being made flowable, e.g., by mechanical vibration” or in short “liquefiable thermoplastic material” or “liquefiable material” or “thermoplastic” is used for describing a material including at least one thermoplastic component, which material becomes liquid (flowable) when heated, in particular when heated through friction, i.e., when arranged at one of a pair of surfaces (contact faces) being in contact with each other and vibrationally moved relative to each other, wherein the frequency of the vibration has the properties discussed hereinbefore. In some situations, for example if the first object itself has to carry substantial loads, it may be advantageous if the material has an elasticity coefficient of more than 0.5 GPa. In other embodiments, the elasticity coefficient may be below this value, as the vibration conducting properties of the first object thermoplastic material do not play a role in the process.

Thermoplastic materials are well-known in the automotive and aviation industry. For the purpose of the method according to the present invention, especially thermoplastic materials known for applications in these industries may be used.

A thermoplastic material suitable for the method according to the invention is solid at room temperature (or at a temperature at which the method is carried out). It preferably includes a polymeric phase (especially C, P, S or Si chain based) that transforms from solid into liquid or flowable above a critical temperature range, for example by melting, and re-transforms into a solid material when again cooled below the critical temperature range, for example by crystallization, whereby the viscosity of the solid phase is several orders of magnitude (at least three orders of magnitude) higher than of the liquid phase. The thermoplastic material will generally include a polymeric component that is not cross-linked covalently or cross-linked in a manner that the cross-linking bonds open reversibly upon heating to or above a melting temperature range. The polymer material may further include a filler, e.g., fibres or particles of material that has no thermoplastic properties or has thermoplastic properties including a melting temperature range that is considerably higher than the melting temperature range of the basic polymer.

In this text, generally a “non-liquefiable” material is a material that does not liquefy at temperatures reached during the process, thus especially at temperatures at which the thermoplastic material of the first object is liquefied. This does not exclude the possibility that the non-liquefiable material would be capable of liquefying at temperatures that are not reached during the process, generally far (for example by at least 80° C.) above a liquefaction temperature of the thermoplastic material or thermoplastic materials liquefied during the process. The liquefaction temperature is the melting temperature for crystalline polymers. For amorphous thermoplastics the liquefaction temperature (also called “melting temperature in this text”) is a temperature above the glass transition temperature at which the becomes sufficiently flowable, sometimes referred to as the ‘flow temperature’ (sometimes defined as the lowest temperature at which extrusion is possible), for example the temperature at which the viscosity drops to below 10⁴ Pa*s (in embodiments, especially with polymers substantially without fiber reinforcement, to below 10³ Pa*s)), of the thermoplastic material.

For example, non-liquefiable material may be a metal, such as aluminum or steel, or a hard plastic, for example a reinforced or not reinforced thermosetting polymer or a reinforced or not reinforced thermoplastic with a melting temperature (and/or glass transition temperature) considerably higher than the melting temperature/glass transition temperature of the liquefiable part, for example with a melting temperature and/or glass transition temperature higher by at least 50° C. or 80° C.

Specific embodiments of thermoplastic materials are: Polyetherketone (PEEK), polyesters, such as polybutylene terephthalate (PBT) or Polyethylenterephthalat (PET), Polyetherimide, a polyamide, for example Polyamide 12, Polyamide 11, Polyamide 6, or Polyamide 66, Polymethylmethacrylate (PMMA), Polyoxymethylene, or polycarbonateurethane, a polycarbonate or a polyester carbonate, or also an acrylonitrile butadiene styrene (ABS), an Acrylester-Styrol-Acrylnitril (ASA), Styrene-acrylonitrile, polyvinyl chloride (PVC), polyethylene, polypropylene, and polystyrene, or copolymers or mixtures of these.

In embodiments in which both, the first and the second object include thermoplastic material and no welding is desired, the material pairing is chosen such that the melting temperature of the second object material is substantially higher than the melting temperature of the first object material, for example higher by at least 50°. Suitable material pairings are for example polycarbonate or PBT for the first object and PEEK for the second object.

In addition to the thermoplastic polymer, the thermoplastic material may also include a suitable filler, for example reinforcing fibers, such as glass and/or carbon fibers. The fibers may be short fibers. Long fibers or continuous fibers may be used, especially for portions of the first and/or of the second object that are not liquefied during the process.

The fiber material (if any) may be any material known for fiber reinforcement, especially carbon, glass, Kevlar, ceramic, e.g., mullite, silicon carbide or silicon nitride, high-strength polyethylene (Dyneema), etc.

Other fillers, not having the shapes of fibers, are also possible, for example powder particles.

Mechanical vibration or oscillation suitable for the method according to the invention has preferably a frequency between 2 and 200 kHz (even more preferably ultrasonic vibration having a frequency between 10 and 100 kHz, or between 20 and 40 kHz) and a vibration energy of 0.2 to 20 W per square millimeter of active surface. The vibrating tool (sonotrode) is, e.g., designed such that its contact face oscillates predominantly in the direction of the tool axis (longitudinal vibration) and with an amplitude of between 1 and 100 μm, preferably around 30 to 60 μm. Such preferred vibrations are e.g. produced by ultrasonic devices as, e.g., known from ultrasonic welding.

In this text, the terms “proximal” and “distal” are used to refer to directions and locations, namely “proximal” is the side of the bond from which an operator or machine applies the mechanical vibrations, whereas distal is the opposite side.

### BRIEF DESCRIPTION OF THE DRAWINGS

Hereinafter, principles and embodiments of the invention are illustrated in drawings. All drawings are schematic and not to scale. The drawings are used to explain the invention and embodiments thereof and are not meant to restrict the scope of the invention. In the drawings, same reference numbers refer to same or analogous elements. Terms designating the orientation like “proximal”, “distal”, etc. are used in the same way for all aspects and drawings. The drawings show:

FIGS. 1 and 2 Embodiments of a method according to the first aspect of the invention;

FIGS. 3 and 4 Exemplary arrangements and shapes of protrusions;

FIGS. 5-7 Embodiments of the step of deforming the protrusion;

FIGS. 8 and 9 Embodiments of a first object including a deformation element;

FIG. 10 An embodiment of the method including a second object with a fastening portion;

FIG. 11 An embodiment with a first object including an elastomer;

FIG. 12 An embodiment including a sealing ring;

FIG. 13 Yet a further embodiment of a method according to the first or second aspect of the invention;

FIG. 14 An embodiment according to the first aspect of the invention including a protrusion that is arranged in an opening of the second object; and

FIGS. 15-19 Further exemplary arrangements and shapes of protrusions.

### DETAILED DESCRIPTION OF THE INVENTION

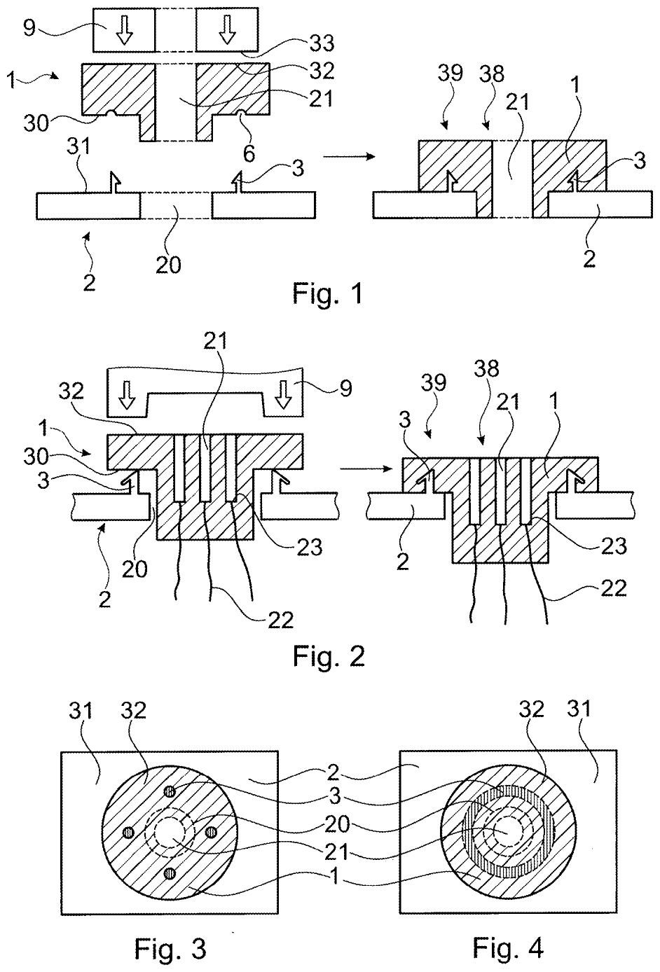

FIG. 1 shows an embodiment of a method according the first aspect of the invention schematically.

In the shown embodiment, a first object 1 including a feedthrough 21 in the shape of a pipe is provide. The first object 1 is made of a thermoplastic material, for example by injection molding, except a possible finishing (for example, coating) of the portions of the first object 1 forming the feedthrough 21.

Further, a second object 2 including a protrusion 3 and an opening 20 is provided.

The protrusion 3 includes an undercut in an axial direction such that the first and second object are secured after bonding against forces normal to the first and second object surface portion.

The protrusions 3 are arranged at a surface of the second object 2 (called the second object surface portion 31 in the following), the surface is intended to be in contact with a corresponding surface of the first object 1 (called the first object surface portion 30 in the following).

The first object 1 is positioned relative to the second object 2 such that the first object surface portion 30 is parallel to the second object surface portion 30 and such that the protrusion 3 is aligned with an intended joining location at the first object 2.

The intended joining location can be given by a shape of the first object 1 that is complementary to a shape of the second object 2, for example a portion of the first object 1 can be dimensioned to engage with the opening 20, and/or with an indentation 6 in the first object surface portion 30, wherein a portion of the protrusion 3 facing the first object surface portion 30 is equipped to engage with the indentation 6.

A relative force between the first object 1 and the second object 2 and mechanical vibration are applied by the use of a sonotrode 9. The sonotrode 9 includes a coupling face 33 that is adapted to a coupling surface 32 of the object (in the embodiment shown the first object 1) to which it is put in contact for applying the relative force and the mechanical vibration. In the embodiment shown, the sonotrode 9 is a ring sonotrode including an opening in extension of the feedthrough 21.

On the right of FIG. 1, the first and second objects after bonding are shown. The protrusion 3 is embedded in thermoplastic material of the first object 1. Further, the feedthrough 21 forms a connection between the side of the second object 2 from which the first object 1 was bonded to the second object 2 and a side opposite to the side from which the first object 1 was bonded to the second object 2.

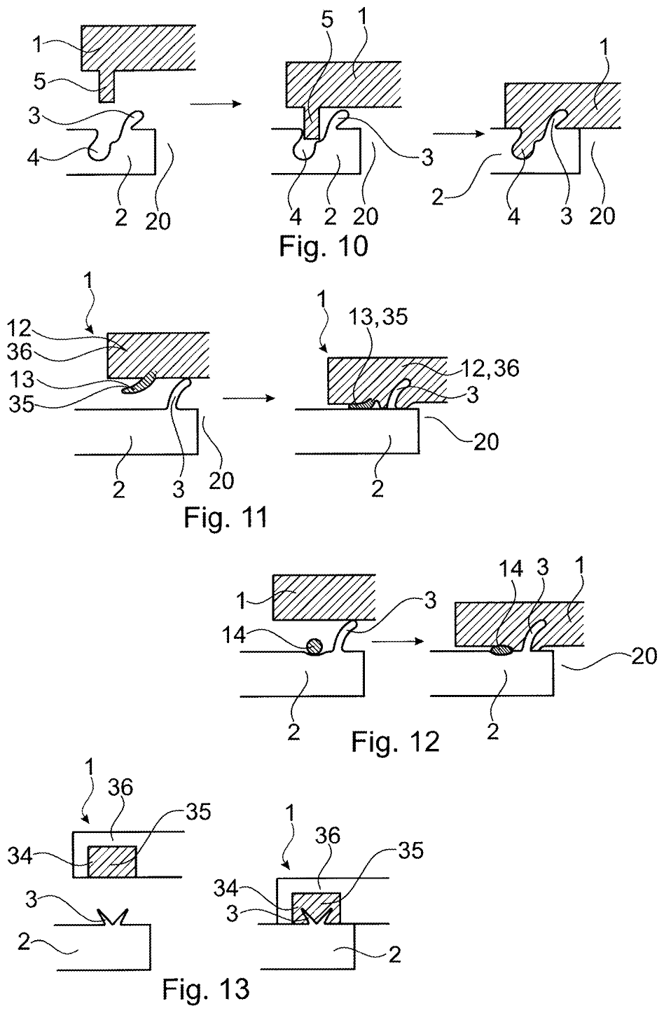

The protrusion 3 can run around the opening 21 continuously, as shown in FIG. 4 for example, and/or other means can be present for a connection between the first object 1 and second object 2 that forms a seal, as shown in FIGS. 10-12, for example.

The steps shown in FIG. 1 are representative for embodiments according to the second aspect of the invention too as embodiments of the second aspect include the steps shown. However, embodiments of the second aspect differ from embodiments of the first aspect in the first and second object provided and in the further step of deforming the protrusion 3, in particular.

FIG. 2 shows a variation of the embodiment shown in FIG. 1, in which a connector for power, (electrical) signals etc. is provided.

The feedthrough 21 of the connector form a plug by extending from a proximal side of the first object 1 towards a distal side of it. However, the feedthrough 21 is not a thoroughgoing feedthrough 21. Rather the feedthrough 21 includes a dead end formed by a contact element 23.

The contact element 23 is in conductive contact to a wire 22. The wire 22 runs from the contact element 23 to the distal end of the first object 1, i.e. to the side of the first object 1 that is opposite to the side from which the first object 1 is bond to the second object 2

On the right of FIG. 2, the first object 1 (connector) and second object 2 after bonding are shown. The protrusion 3 is embedded in thermoplastic material of the first object, wherein the protrusion 3 and the thermoplastic material form a positive fit connection.

FIGS. 3 and 4 depict exemplary arrangements and shapes of the protrusion 3. A top view of a first object 1 bonded on top of the second object 2 is shown, i.e. the coupling surface 32 of the first object 1 including an inlet to the feedthrough 21 and the part of the second object surface portion 31 that is not in contact with the first object surface portion 30 is visible, whereas the indicated position(s) and shape(s) of the protrusion(s) 3, and the opening 20 are covered by the first object 1.

Four distinct protrusion 3 are shown in FIG. 3. One can envisage to user less, for example 1, 2 or 3 distinct protrusion, or more, for example 5, 6, 8 or 10, distinct protrusion.

In particular, distinct protrusion are very suitable for methods according to the second aspect of the invention, i.e., in application aiming for the bonding of a first object 1 that does not need to be a connecting element and hence does not need to have a feedthrough 21 to a second object 2 that does not need to have an opening 20.

The distinct protrusions can be arranged according to the needs of the bonding to be established, e.g., according to a load distribution expected during use of the bonded first and second objects, and/or they can be arranged such that a step of deforming the protrusions 3 can be performed without one protrusion 3 hindering the deformation of another protrusion 3.

The protrusion shown in FIG. 4 includes a shape such that the protrusion runs uninterruptedly, i.e., continuously, around the opening 20. Such a protrusion 3 is very suitable for the generation of a sealed connection between the first and second objects.

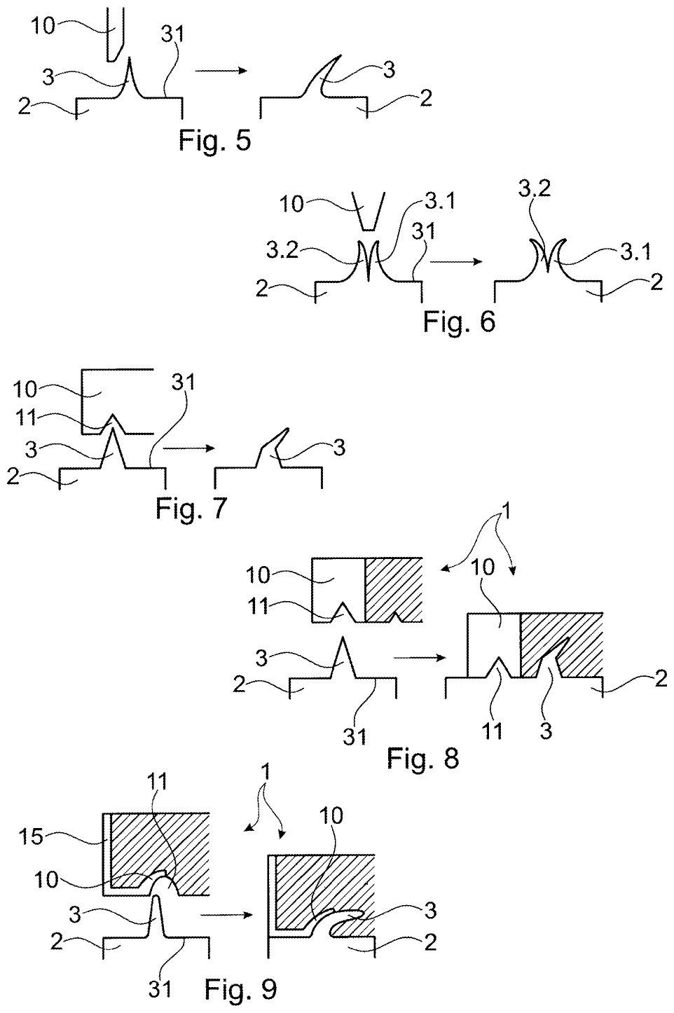

FIGS. 5-7 show embodiments of the step of deforming the protrusion 3. The situation at the beginning of the step is shown on the left in each figure. The situation at the end of the step is shown on the right in each figure.

The steps results in a protrusion 3 that includes an undercut such that a separation of the first object 1 and the second objects 2 in a direction normal to the second object surface 31 is prevented. This step can be present in all embodiments according to the first or second aspect of the invention.

Deformation elements 10 that include a higher resistivity against deformation than the protrusion 3 in the case of a force being applied along an axis that runs parallel to the second object surface portion 31 are shown. In other words: If the deformation element 10 is pushed against the protrusion 3 by a movement that is parallel to the second object surface portion 31, it is the protrusion 3 that deforms.

FIG. 5 shows a deformation element 10 that has the shape of a rod. The cross-section of the rod along a plane parallel to the second object surface portion 31 can be rectangular or round, for example.

The rod can include a recess such that a surface of the rod is in contact with a surface of the protrusion 3 during the step of deforming the protrusion 3.

The rod can extend in a direction normal to the drawing plane. In particular, the rod can be adapted to the shape and/or extension of the protrusion 3.

In the embodiment of FIG. 6, the deformation element 10 has the shape of a wedge wherein the protrusion 3 includes a first protrusion portion 3.1 and a second protrusion portion 3.2. At least the tips of the protrusion portions are spaced apart such that a distal end portion of the wedge can be pushed between the first and second protrusions.

Further, the first protrusion portion 3.1 can be separate from the second protrusion portion 3.2 for most of their extensions along an axis perpendicular to the second object surface portion 31, at least. Hence, the wedge pushes the first and second protrusion portions away from each other but does not divide a one piece protrusion body into two portions.

The protrusion 3 is deformed by pushing the wedge towards the second object 2 along an axis normal to the second object surface portion 31.

FIG. 7 shows a deformation element 10 that includes a deformation recess 11. The deformation recess 11 is arranged to engage with the protrusion 3 and to deform the protrusion 3 by a movement of the deformation element 10 parallel to the second object surface portion 31.

FIGS. 8 and 9 depict embodiments in which the first object 1 includes the deformation element 10.

In the embodiment of FIG. 8, the first object 1 includes a first part including the deformation element 10, for example a deformation element 10 according to FIG. 7, and a second part next to the first part including the thermoplastic material.

The first and second parts of the first object 1 are attached rigidly to each other.

A method including a first object 1 as shown in FIG. 8 includes the further steps of:
Engaging the deformation recess 11 and the protrusion 3, for example by pushing the protrusion 3 into the deformation recess 11;
Deforming the protrusion 3 by a movement of the first object 1, the movement being a movement relative to the second object 2 and being along an axis parallel to the second object surface portion 31;
Disengaging the protrusion 3 and the deformation recess 11;

FIG. 9 shows an embodiment, in which the deformation recess 11 defines the location of embedding the protrusion 3 in the thermoplastic material, too.

This is done by a deformation recess 11 that includes a wall that is partly formed by the deformation element 10 and partly by the thermoplastic material.

The part of the deformation element 10 that forms the wall of the deformation recess 11 can be part of a load frame 15. The load frame 15 can be rigidly connected to a tool used for guiding the first object 1. In particular, it can be rigidly connected to the sonotrode 9.

A method including a first object 1 as shown in FIG. 9 includes the further steps of:
Engaging the deformation recess 11 and the protrusion 3, for example by pushing the protrusion 3 into the deformation recess 11;
Deforming the protrusion 3 by a movement of the first object 1, the movement being a movement relative to the second object 2 and being along an axis parallel to the second object surface portion 31; and

A further positioning of the first object 1 relative to the second object 2 may not be needed, anymore.

An alternative method including a first object 1 as shown in FIG. 9 includes the step of engaging the deformation recess 11 and the protrusion 3, for example by pushing the protrusion 3 into the deformation recess 11, and further includes modifying the step of applying a relative force and mechanical vibration such that the step includes the following two sub-steps:
Applying a relative force between the second and first objects without applying mechanical vibration, such that the protrusion 3 deforms whereas the thermoplastic material remains in its solid state. In other words, the protrusion deforms but the first object 1 does not deform.
Applying a relative force between the second and first objects and applying mechanical vibration to the assembly of the first and the second object until at least a flow portion of the thermoplastic material becomes flowable and flows around the deformed protrusion (3).

The relative force applied in the step without mechanical vibration can differ from the relative force applied in the step including the impingement of mechanical vibration.

A partial or complete release of the relative force applied can be done between the step without mechanical vibration and the step including the impingement of mechanical vibration.

FIGS. 10-12 show embodiments that are in particular—but not only—suitable for connections between the first object 1 and the second object 2 that form a seal.

In the embodiment according to FIG. 10, the second object 2 includes a fastening portion 4 in the shape of cavity that forms an undercut with respect to axial directions. The cavity can be accessed by an opening in the second object surface portion 31.

The first object 1 includes a thermoplastic extension 5 that protrudes from the first object surface portion 30.

The dimensions of the thermoplastic extension 5 can be adapted to the dimensions of the fasting portion 4. This can include an extension in a direction normal to the drawing plane.

A method including a first object 1 and a second object 2 as shown in FIG. 10 includes the further steps of:
Positioning the first object 1 relative to the second object 2 such that the thermoplastic extension 5 is in contact to and/or engages with the protrusion 3; and
Pushing the thermoplastic extension 5 into the fastening portion 4;

Further, the step of applying the relative force between the first object 1 and the second object 2 and applying mechanical vibration further includes liquefying the thermoplastic extension 5 such that the thermoplastic material and the fastening portion 4 form a positive fit connection after re-solidification of the thermoplastic material. In particular, the thermoplastic extension 5 is liquefied such that is fills the cavity of the fastening portion 4 at least partly.

In the embodiment according to FIG. 11, the first object 1 includes a first portion 12 including or consisting of the thermoplastic material 36 and a second portion 13 consisting of an elastomer 35.

The second portion 13 protrudes from the first object surface portion 30 and is arranged to deform elastically, in particular if a force normal the first object surface portion 30 is applied.

An embodiment of the method providing said first object 1 including the first portion 12 and the second portion 13 does not differ from any other embodiment according to the first or second aspect of the invention. However, the relative force and mechanical vibration are applied until the second portion 13 is compressed between the first object surface portion 30 and the second object surface portion 31.

The embodiment shown in FIG. 12 is an alternative to the embodiment shown in FIG. 11, wherein the second portion 13 is replaced by a sealing ring 14.

In the embodiment shown, the sealing ring is positioned within a recess in the second object surface portion 30. The recess runs around the opening 20 of the second object is more distant from the opening 20 than the protrusion 3.

More in general, a sealing ring of the described kind can be shaped and placed to run around the protrusion or to run around the opening, with the protrusion running around the sealing ring.

FIG. 13 depicts a further embodiment of the first or second aspect of the invention, wherein the first object 1 includes an elastomeric material 36 in a recess 34 of the first object 1, wherein the thermoplastic material 36 forms the recess.

In the embodiment shown, the elastomeric material 36 has thermoplastic properties, too. In other words, it is a thermoplastic elastomer.

The thermoplastic material 36 has characteristics such that it does not deform during a method according to any embodiment according to the first or second aspect of the invention.

In a method including a first object 1 as shown in FIG. 13, the step of positioning the first object 1 relative to the second object 2 includes bringing the recess 34 in contact with the protrusion 3. Further, it is the elastomeric material 36 that becomes flowable in the step of applying the relative force and the mechanical vibration. Hence, the protrusion 3 is embedded in the elastomeric material 36.

Consequently, the first object 1 and the second object 2 are bonded such that a limited movement of the first object 1 relative to the second object 2 is still possible after bonding. In particular, the recess 34 is dimensioned such that a movement parallel to the first and second object surface portions is possible, for example by a depth of the recess that is only slightly larger than a height of the protrusion 3, wherein the depth of the recess is its extension perpendicular to the first object surface portion 30 and the height of the protrusion 3 is its extension perpendicular to the second object surface portion 31.

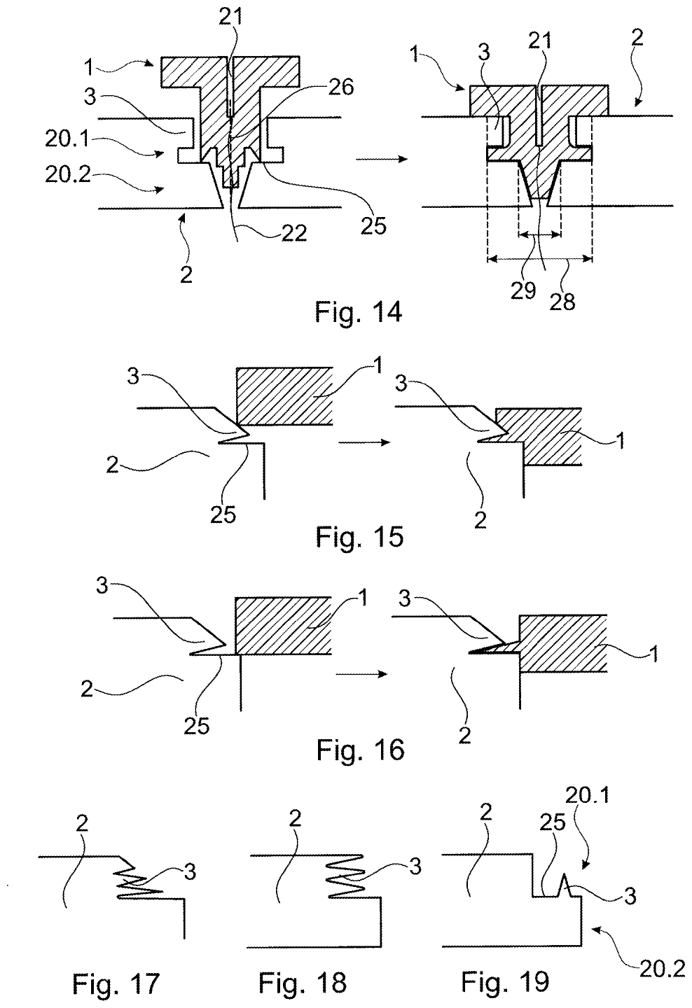

FIG. 14 shows an embodiment according to the first aspect of the invention including the protrusion 3 arranged in the opening 20 of the second object 2.

In the embodiment shown, the protrusion 3 is formed by protruding from a lateral wall of the opening 20.

The embodiment of FIG. 14 shows the optional feature of the opening 20 having a first portion 20.1 with a first diameter 28 and a second portion 20.2 with a second diameter 29, wherein the second diameter 29 is smaller than the first diameter 28. In the embodiment shown, the decrease from the first diameter 28 to the second diameter 29 is step-wise such that a surface 25 is formed, the surface 25 being oriented perpendicular to a longitudinal axis 26 of the opening 20.

The protrusion 3 protrudes from the lateral wall of the first portion 20.1 such that the effective size of the opening 20 in the first portion 20.1 depends on the position along the longitudinal axis 26. In particular, the protrusion 3 protrudes from the lateral wall of the first portion 20.1 such that the first diameter 28 is diminished locally.

The surface 25 formed by the decrease in diameter is arranged to cause the thermoplastic material of the first object 1 that is in contact with the surface 25 (this means the flow portion of the first object 1) after the step of positioning the first object 1 relative to the second object 2 to become flowable during the step of applying the relative force and the mechanical vibration. Further, it serves to direct flowable thermoplastic material in a manner that it flows partly around the protrusion 3, at least.

The surface 25 formed by the decrease in diameter is arranged distally of the protrusion 3. Hence, a positive-fit connection between the first and second object is formed after the flowable thermoplastic material has been directed in radial direction and after re-solidification of the thermoplastic material.

One can envisage other orientations of the surface 25 formed by the decrease in diameter as well as other shapes and positions of the protrusion 3 protruding from the lateral wall than shown in FIG. 14 as long the surface 25 and the protrusion 3 are arranged relative to each other in a manner that a positive-fit connection between the first and second object is formed.

FIGS. 15-18 show further exemplary arrangements and shapes of protrusions 3. The arrangements and shapes shown can be used in the method according to the first aspect of the invention, in particular in an embodiment thereof as disclosed in FIG. 14. However, the arrangements and shapes shown can also be used in the method according to the second aspect of the invention, wherein the lateral wall is a sidewall of the second object 2 and the surface 25 is formed by a step in said sidewall, for example.

In FIG. 15 the protrusion 3 is tapered and the first object 1 is positioned in the step of positioning the first object 1 relative to the second object 2 in a manner that it is pressed against a proximal surface of the tapered protrusion 3 during the step of applying the relative force and the mechanical vibration.

The surface 25 is arranged relative the tapered protrusion 3 in a manner that it directs flowable thermoplastic material radially behind a distal surface of the tapered protrusion 3.

In FIG. 16 the protrusion 3 is tapered and the first object 1 is positioned in the step of positioning the first object 1 relative to the second object 2 in a manner that it is pressed against the surface 25 during the step of applying the relative force and the mechanical vibration.

The surface 25 is arranged distally of the tapered protrusion 3 such that it directs flowable thermoplastic material radially behind a distal surface of the tapered protrusion 3.

In FIG. 17, the second object 2 includes a plurality of protrusions 3 that are arranged on the lateral wall (the sidewall, as the case may be). The length of the protrusions 3 depends on their position on the lateral wall and increases from proximally to distally. This has the effect that the first object 1 does not need to be positioned with high accuracy during the step of positioning the first object 1 relative to the second object 2 and/or that the objects, in particular the first object 1, does not need to be produced with tight production tolerances. This is because a second object 2 as shown in FIG. 17 offers different possible locations where thermoplastic material of the first object 1 can be made flowable and different possible locations where a positive-fit connection can be established.

The plurality of protrusions 3 shown in FIG. 18 do not vary in length. This can cause a more reliable, rigid and/or stable bond between the first and second object as a plurality of positive-fit connections can be formed.

FIG. 19 shows a protrusion 3 that is arranged on the surface 25 formed by the decrease in diameter or on the step in the sidewall of the second object 2.

The protrusion 3 can form an undercut or it can be deformable to form an undercut as disclosed above.

The protrusion 3 arranged on the surface 25 (the step in the sidewall as the case may be) can be combined with the protrusion 3 protruding from the lateral wall (the sidewall). The combination of a protrusion arranged on the surface 25 and a further protrusion arranged on the lateral wall can cause a bonding of the first and second object based on positive-fit connections along perpendicular axes.

1. A method of bonding a first object to a second object, wherein the first object is a connecting element, the method comprising the steps of:
providing the second object, the second object comprising a protrusion and an opening;
providing the first object, the first object comprising a thermoplastic material and a feedthrough;
positioning the first object relative to the second object such that an assembly of the first and the second object is formed;
applying a relative force between the second and first objects and applying mechanical vibration to the assembly of the first and the second object until at least a flow portion of the thermoplastic material becomes flowable and flows around the protrusion;
causing the thermoplastic material to re-solidify.

2. The method according to claim 1, wherein the feedthrough comprises at least one of a conduit of a fluid, and an electrical feedthrough.

3. The method according to claim 2, wherein the first object is at least one of a plug, and of a socket.

4. A method of bonding a first object to a second object, comprising the steps of:
providing the second object, the second object comprising a protrusion, wherein the protrusion does not form an undercut;
providing the first object, the first object comprising a thermoplastic material;
deforming the protrusion;
positioning the first object relative to the second object such that an assembly of the first and the second object is formed;
applying a relative force between the second and first objects and applying mechanical vibration to the assembly of the first and the second object until at least a flow portion of the thermoplastic material becomes flowable and flows around the protrusion;
causing the thermoplastic material to re-solidify.

5. The method according to claim 4, wherein deforming the protrusion comprises deforming the protrusion to have an undercut with respect to axial directions.

6. The method according to claim 4, wherein the second object comprises an opening, and wherein positioning the first object relative to the second object comprises positioning the first object in a manner that after the step of causing the thermoplastic material to re-solidify the first object extends at least partially through the opening.

7. The method according to claim 1, wherein the protrusion runs around the opening.

8. The method according to claim 7, wherein after the step of causing the thermoplastic to re-solidify the re-solidified thermoplastic material together with the protrusion forms a seal around the opening.

9. The method according to claim 1, comprising the step of deforming the protrusion and further comprising the steps of providing a deformation element and of positioning the deformation element relative to the protrusion, and wherein the step of deforming the protrusion comprises deforming the protrusion by applying a force to the protrusion via the deformation element.

10. The method according to claim 9, wherein the first object comprises the deformation element.

11. The method according to claim 1, wherein the step of positioning the first object relative to the second object comprises bringing the thermoplastic material of the first object in contact with the protrusion.

12. The method according to claim 1, wherein the first object comprises a first portion comprising the thermoplastic material and a second portion comprising an elastomer.

13. The method according to claim 12, wherein the second portion is arranged and the relative force and mechanical vibration are applied for a time sufficient such that the second portion is pressed against the second object.

14. The method according to claim 4, wherein in the step of providing the second object the second object has an opening, and wherein the method further comprises the step of positioning a sealing ring around the opening.

15. The method according to claim 1, wherein the thermoplastic material becomes soft but not liquid during the step of applying the relative force and mechanical vibration.

16. The method according to claim 1, wherein the second object is a die cast object.

17. The method according to claim 16, wherein the protrusion is made by die casting, optionally with a post-processing step.

18. The method according to claim 4, wherein the second object comprises a fastening portion having a positive fit shape with an undercut, wherein the step of positioning the first object relative to the second object comprises positioning an extension of thermoplastic material relative to the fastening portion and wherein the step of applying the relative force and mechanical vibration causes the extension of the thermoplastic material to flow such that the fastening portion and the extension constitute a positive fit between the first and second object after re-solidification of the thermoplastic material.

19. The method according to claim 18, wherein the step of providing a second object comprises providing a second object comprising an opening and wherein the fastening portion runs around the opening.

20. The method according to claim 1, wherein the first object comprises a recess in which thermoplastic material is arranged and wherein the step of positioning the first object relative to the second object comprises bringing the protrusion in contact with the thermoplastic material arranged within the recess.

21. A connecting element for use in a method according to claim 1, wherein the connecting element comprises a thermoplastic material, an elastomeric material, and a feedthrough, wherein the thermoplastic material and the elastomeric material have characteristics that differ such that one of the thermoplastic material and the elastomeric material softens at a lower applied force and at lower applied mechanical energy compared to the other one.

22. The connecting element according to claim 21, wherein the elastomeric material is arranged in a recess formed by the thermoplastic material and wherein it is the elastomeric material that softens at a lower applied force and at lower applied mechanical energy.

23. The connecting element according to claim 21, wherein the elastomeric material is arranged at the connection element to form a seal and wherein it is the thermoplastic material that softens at a lower applied force and at lower applied mechanical energy.

24. A connecting element for use in a method according to claim 1, the connecting element comprising a central portion with an electrical feedthrough or a feedthrough for a fluid, and the connecting element further comprising a peripheral portion, the peripheral portion running around the central portion, the peripheral portion comprising a proximally facing coupling surface and a distally facing connecting element surface portion, the connecting element surface portion comprising a thermoplastic material.
